(19) United States
(12) Patent Application Publication
(10) Pub. No.: US 2011/0092324 A1
(43) Pub. Date: Apr. 21, 2011

(54) CONTINUOUSLY VARIABLE BELT DRIVE SYSTEM

(75) Inventor: Joshua L. Roby, Battle Creek, MI (US)

(73) Assignee: BORGWARNER INC., Auburn Hills, MI (US)

(21) Appl. No.: 12/921,211

(22) PCT Filed: Mar. 2, 2009
(86) PCT No.: PCT/US09/35671

§ 371 Date: Dec. 30, 2010

Related U.S. Application Data
(60) Provisional application No. 61/036,067, filed on Mar. 12, 2008.

(51) Int. Cl. F16H 9/14; F16H 55/56

(52) U.S. Cl. 474/8

(57) ABSTRACT

The present invention provides a continuously variable belt pulley transfer system that addresses prior deficiencies with CVT-type systems, particularly when used with accessory drive systems. The continuously variable belt drive system includes a driving pulley assembly and a driven pulley assembly, with a continuous belt transferring rotary motion between them. A direct electronic actuation mechanism is used for controlling ratio changes on the pulley transfer assembly. An integrated stepper motion is used as the prime mover for the mechanism. A differential planetary roller screw mechanism converts the rotary motion from the stepper motor to axial motion for actuating the sheave poison of the V-shaped belt.

### TECHNICAL FIELD

The present invention relates to continuously variable belt drive systems, and more particularly to a continuous variable belt drive system with direct electronic actuation.

### BACKGROUND OF THE INVENTION

The present invention concerns continuously variable belt drive systems, the most popular of which are the continuously variable transmission (CVT) systems. CVT systems are used in automobiles, for example, to allow the transmission to shift smoothly between various drive ratios. These CVT transmission systems typically use a hydraulic actuation system for positioning the sheaves and affecting a drive ratio change. This actuation method is effective for transmissions where they are highly integrated into the vehicle drive train. However, when applying a CVT-type system (generally called a “continuously variable belt drive” system) for less integrated applications, such as driving a cooling fan, the time and cost of integrating a hydraulic actuation system is often prohibitive. Hydraulic actuation systems also typically rely upon engine oil which means that devices must be taken into account when designing o the oil circuit for the engine.

Automotive vehicles include a cooling system to dissipate heat developed by the vehicle power plant, such as an internal combustion engine. In a typical automotive vehicle, the lubrication system provides some cooling function as hot lubricant is pumped away from the engine. However, the bulk of the cooling requirements for an automotive vehicle is accomplished by air flowing through the engine compartment and across the radiator. Coolant flowing around the power plant extracts heat from the engine, which is subsequently dissipated through the vehicle radiator. In automotive vehicles, the engine compartment is designed to permit flow of ambient air through the compartment and past the radiator. In most vehicles, a cooling fan is provided that increases the flow of air across the radiator. In some vehicle installations, the fan is driven by an electric motor that is independent of the vehicle engine. For smaller passenger cars, the electric motor approach can satisfy the cooling needs for the vehicle. However, unlike passenger cars, heavy trucks and other commercial vehicles typically cannot use electric motors to drive the cooling fan. For a typical vehicle of this type, the cooling fan would require a significant amount of horsepower from the engine to cool it, which translates to unreasonably high electrical power requirements.

A wide range of technology is available to transmit power from the engines to the rotating cooling fans. These include on/off clutches and viscous fan drives. In either instance, a continuous belt is utilized to transfer rotational energy from the vehicle engine to the cooling fan or the fan drive system. CVT-type systems have not been commonly applied in accessory drive systems.

Ideally, the transfer drive assembly would turn the cooling fan only as fast as necessary to maintain an optimal engine temperature. Controlling the cooling fan speed conserves power and improves the engine's overall efficiency. In addition, the transfer drive assembly should have the ability to turn the fan faster (i.e. at a higher pulley drive ratio) at lower engine speeds than at higher engine speeds because the cooling requirements for the engine can be greater during operation at low speed and high torque.

Thus, it is an object of the present invention to provide an improved mechanism for regulating the speed of a cooling fan for a cooling system of a vehicle, particularly an accessory drive system. It is another object of the present invention to provide an improved continuously variable belt drive system for use as an accessory drive cooling system.

### SUMMARY OF THE INVENTION

The present invention provides a continuously variable belt pulley transfer system that addresses prior deficiencies with CVT-type systems, particularly when used with accessory drive systems. The continuously variable belt drive system belt transferring rotary motion between them. The pulleys are each formed by forward and rear sheaves that define opposed conical surfaces. The drive ratio between the pulleys is determined by the position of the V-shaped belt between the conical surface of the sheaves.

A direct electronic actuation mechanism is used for controlling ratio changes on the pulley transfer assembly. An integrated stepper motor is used as the prime mover for the mechanism. A differential planetary roller screw mechanism converts the rotary motion from the stepper motor to axial motion for actuating the sheave position.

The stepper motor preferably uses a permanent magnetic rotor member. This eliminates the requirement to transfer electrical power to rotating components. The stepper motor is also easily packaged behind the driven sheave which minimizes the axial length of the assembly. The stepper motor assembly also maintains the rotor in a fixed position if electrical power is lost.

These and other objects, as well as benefits of the invention, can be readily discerned from the following written description of the invention, as illustrated by the accompanying figures, and when construed in accordance with the appended claims.

### BRIEF DESCRIPTION OF THE DRAWINGS

FIG. 1 is a schematic representation of an engine, transmission and cooling system.

FIG. 2 is a schematic representation of one type of transfer drive assembly utilizing a continuous belt and rotating pulley.

FIGS. 3A and 3B are perspective views and partial cross-sections of a continuously variable belt drive system in accordance with an embodiment of the present invention.

FIG. 4 illustrates armature poles in accordance with an embodiment of the present invention.

FIGS. 5 and 5A illustrates a stepper motor rotor in accordance with an embodiment of the present invention.

FIG. 6 illustrates a position control nut for use in an embodiment of the present invention.

FIG. 7 illustrates a planetary roller screw member for use in an embodiment of the present invention.

### DESCRIPTION OF PREFERRED EMBODIMENTS

For the purpose of promoting and understanding of the principles of the present invention, reference will now be made to the embodiments illustrated in the drawings and specific language will be used to describe them. It will nevertheless be understood that no limitation as to the scope of the invention is hereby intended. The invention includes any alternatives and other modifications in the illustrated devices and described methods and further applications of the principles of the invention which would normally occur to persons of ordinary skill in the art to which the invention relates.

The present invention concerns a continuously variable belt drive system, or transfer drive assembly, particularly suited for driving accessory devices in an automotive vehicle. Of course, the principles of the present invention can be employed in a variety of applications where continuously or infinitely variable speed ratios are desired.

In general terms, the invention provides a driving member assembly that incorporates mechanical tensioning features to maintain proper tension on a V-shaped belt driven by the rotating sheaves of the driving pulley. Continuously variable transmission systems generally utilize a continuous belt having a V-shaped cross-section. The belt is configured to engage conical friction surfaces of opposing pulley sheaves. The continuously variable feature of the CVT system is accomplished by changing the distance between the sheaves of a particular pulley.

As the sheaves are moved apart, the V-shaped belt moves radially inward to a lower radius of rotation or pitch. As the sheaves are moved together, the conical surfaces push the V-shaped belt radially outward so that the belt is riding at a larger diameter. The typical CVT system is sometimes referred to as an “infinitely variable transmission” in that the V-belt can be situated at an infinite range of radii depending upon the distance between the conical pulley sheaves. When a continuously variable belt drive system is used with a cooling fan, the speed of the cooling fan can be equated to the amount of cooling needed or required for the engine.

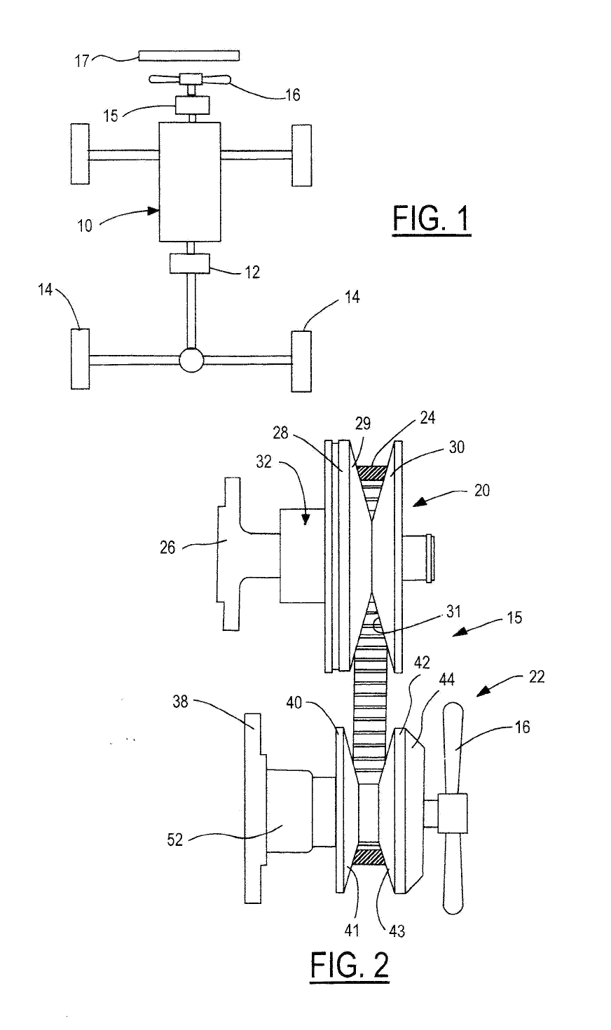

In a typical vehicle installation, whether over the road or off highway, the cooling fan is driven by the vehicle engine. In one typical installation shown in FIG. 1, an engine 10 is also coupled to a transfer drive assembly 15. The assembly 15 provides power directly to a cooling fan 16 that is typically situated adjacent the vehicle radiator 17. FIG. 1 also depicts a transmission mechanism 12 which is used to drive the wheels 14 of the vehicle.

A CVT-type pulley system for moving pulley sheaves and changing the drive ratio is shown in FIG. 2. In general, the transfer drive assembly 15 includes a driving member assembly 20 that is connected to a source of rotary power, such as an internal combustion engine 10, and a driven member assembly 22 which is connected to a driven device, such as an auxiliary device associated with the vehicle. In accordance with a preferred use of the present invention, the driven member assembly 22 is connected to a cooling fan 16 forming part of the engine cooling system. A continuous belt 24 is connected between the pulleys of the driving member assembly 20 and the driven member assembly 22. The belt is preferably V-shaped and can be made of a variety of known configurations and materials. The belt 24 is driven by frictional contact with the pulley of the driving member assembly. Likewise, the driven member assembly is propelled through frictional contact with the rotating belt.

The driving member assembly 20 includes a driving shaft 26 that can be configured to mount to the drive shaft of the engine 10 or an auxiliary or PTO shaft driven by the vehicle engine. The driven member assembly 22 can include a mounting member 44 to which the engine cooling fan 16 is connected.

The driving member assembly 20 includes a rear sheave 28 having a conical belt engagement surface 29, and a forward sheave 30 having a conical belt engagement surface 31. As is well known in the art, the two sheaves 28 and 30 combine to form a pulley for driving the continuous belt 24. The V-shape of the belt conforms to the opposing conical surfaces 29 and 31 to provide solid frictional contact during rotation of the driving member assembly 20.

The driving member assembly can include a belt tensioning mechanism 32 as conventionally known in the CVT art. This maintains proper belt tension and ensures sufficient transfer of rotary motion between the two pulleys. It also can eliminate belt squeal associated with a loose or worn belt.

It is also possible to allow one or both of the driving member assembly or driven member assembly to slide axially along its associated shaft. This can be accomplished in any of the conventional ways known today. Changing the pulley ratio between the driving member and driven member assemblies can cause the centerline of the belt to shift axially relative to the driving shaft. This can skew the belt between the two pulleys and increase belt wear and risk of belt breakage. Allowing one or both of the pulley assemblies to slide axially maintains proper alignment between them.

A second component of the continuously variable drive assembly 15 is the driven member assembly 22. The assembly 22 can be fixed to the vehicle, such as to the engine, by a mounting flange 38 on housing 74. The driven member assembly 22 also defines a rotating pulley by the combination of a rear sheave 40 and a forward sheave 42. As with the driving member assembly, the two driven sheaves 40 and 42 o confine conical engagement surfaces 41 and 43, respectively. The fan mounting member 44 is attached to the forward sheave 42 so that rotating of the pulley sheaves causes rotation of the fan mounting member 44, and in turn rotation of the fan 16 which is attached to the mounting member 44.

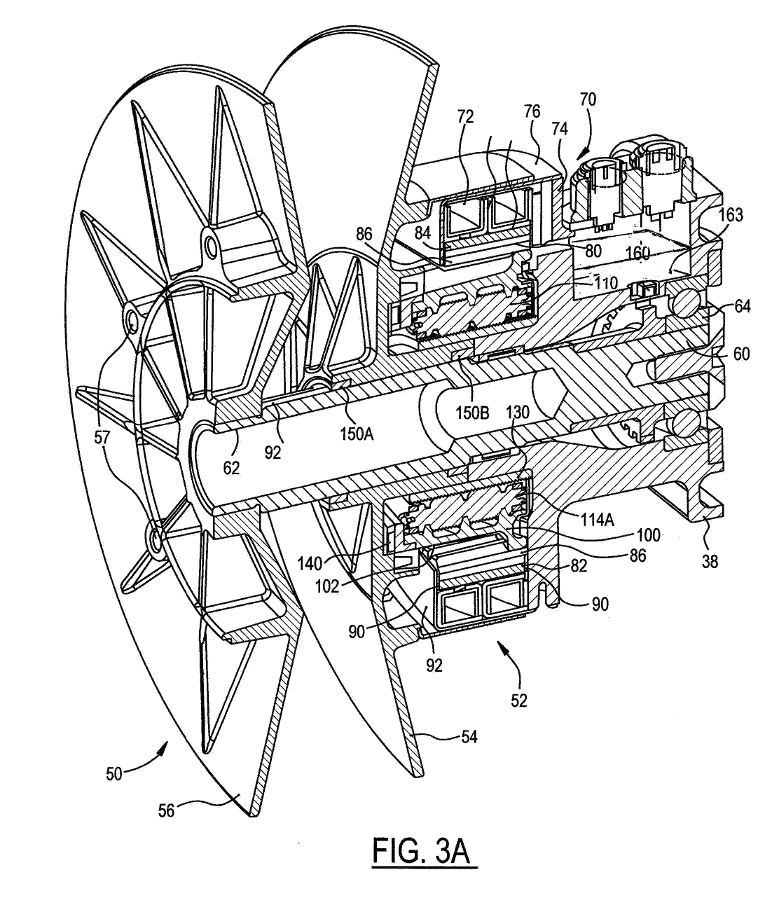

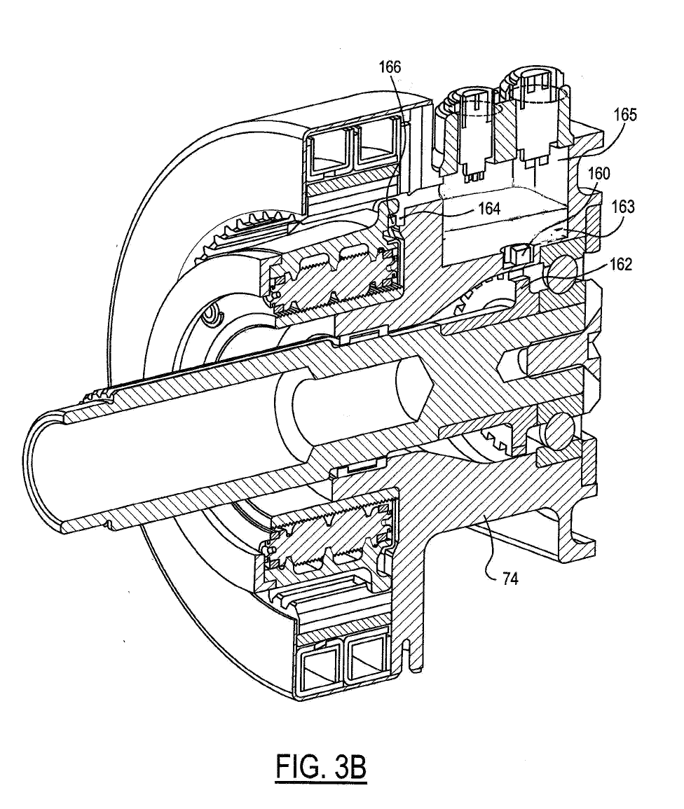

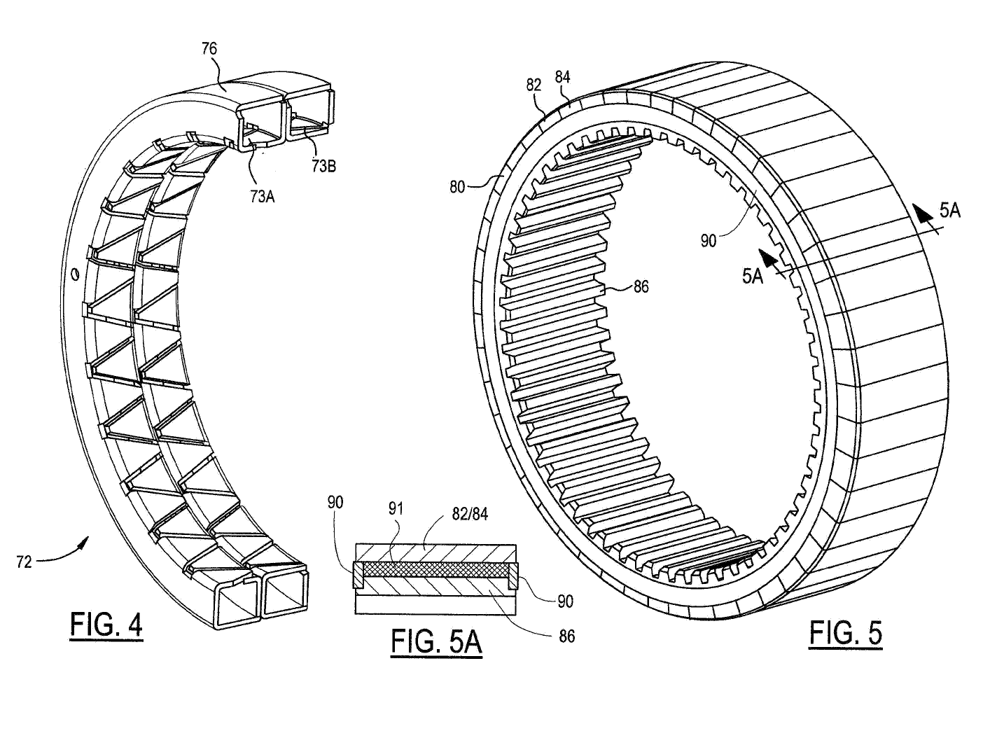

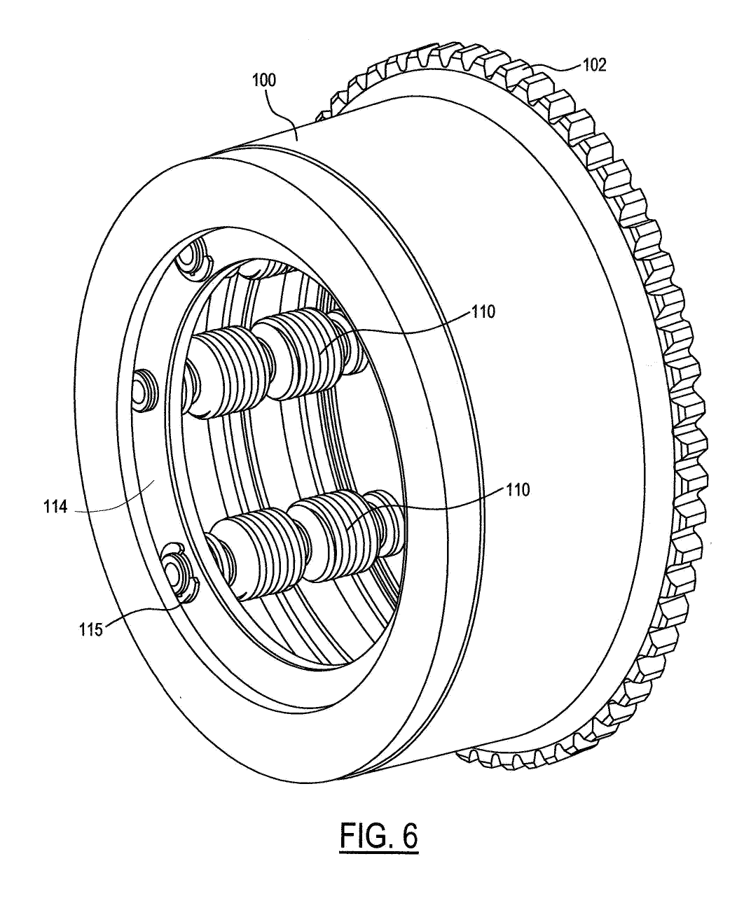

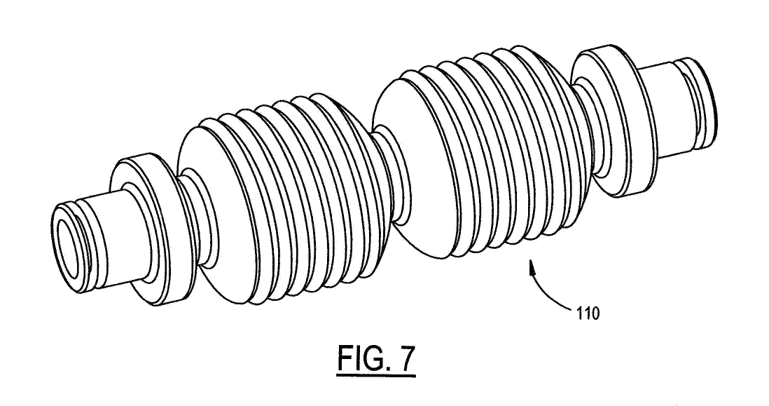

A preferred embodiment of the present invention is shown in FIGS. 3-7. The continuously variable ratio feature of the assembly 50 is accomplished by a ratio adjustment mechanism or system 52 which is integrated into a driven member assembly. In general terms, the adjustment mechanism adjusts the position of the rear sheave 54 relative to the forward sheave 56 to increase or decrease the gap between the two sheaves. As explained above, moving the two sheaves together causes the V-belt to be forced radially outward to a larger driven radius. Similarly, moving the two sheaves apart allows the belt to drop deeper into the pulley groove, and therefore run at a smaller driven radius.

A fan member 16 or fan member assembly is mounted to the forward sheave 56 so that rotation of the pulley sheaves causes rotation of the fan member. For this purpose, a number of mounting holes 57 are provided on the front surface of the forward sheave 56.

In this regard, it is preferred that the adjustment mechanism 52 be associated with the driven pulley, rather than the driving (or drive) pulley. However, a similar mechanism can be incorporated into the driving member assembly, or into both of the driving and driven assemblies where desired.

The two sheaves 54 and 56 are mounted on a central axle or shaft member 60. The front sheave 56 is fixedly secured to the shaft or axle 60 while the rear sheave 54 is slidingly positioned on the axle member 60. The rear sheave is typically splined to the shaft. In the drawings, a central bore 62 is also shown in the axle member 60. The bore 62 can be provided to reduce the weight of the assembly 50; the bore 62 can also be used to assist in mounting a fan member or fan member assembly to the forward sheave 56. The axle 60 is rotatingly mounted to the mounting housing 38 by a bearing set 64.

The embodiment shown in FIGS. 3-7 has a prime mover that includes a stepper motor 70 integrated into the driven sheave assembly mounting housing 74. The stepper motor 70 has an armature 72 which is directly attached to the mounting housing 74. The armature 72 includes a pair of coils 73A, 73B that may be wired either unipolar or bipolar configuration. The stepper motor in the embodiment shown has a can-stack design in which the armature poles 76 and magnetic path are constructed with four intermeshing stampings. The stepper motor also includes a rotor member 80 which consists of alternating north pole magnets 82 and south pole magnets 84 circumferentially attached to a splined rotor core 86. The rotor assembly also has a flux ring 91 that completes the magnetic circuit path (see FIG. 5A). The rotor assembly is axially isolated from the stationary housing by a pair of wear rings 90 and secured in place by a retaining plate 92.

As the rotor assembly turns, it translates rotary motion to the position control nut member 100 through a splined interface 102. The position control nut member 100 has a series of planetary threaded roller screws 110 that roll inside and are held in radial position by spacer rings 114 and snap rings 115. The rings 114 maintain the roller screws 110 in alignment.

As the position control nut member 100 rotates, it translates along a threaded sleeve member 130 via the planetary roller screw members 110. The position control nut member 100 pushes on the rear sheave 54 through the roller thrust bearings 140 and positions the rear sheave 54 to change the drive ratio.

The rear sheave 54 further incorporates front and back guide rings 150A and 150B which concentrically mate with the splined shaft 60 through a close running fit to minimize sheave wobble.

Fan speed is measured using a gear sensing Hall Effect Device (HED) 160 which senses a variation in magnetic field as the teeth of the ferrous speed sensing gear 162 pass by. The home sheave position is sensed through a second standard HED 164 and a small magnet 166 which is attached to the position control nut housing 100. A printed circuit board 163 with a controller stepper motor drive is provided in cavity 165 in the housing 74.

The present invention provides a direct electronic actuation mechanism for o controlling the ratio changes on a continuously driven belt drive system. The drive ratio is controlled from the output sheave which has a fixed mounting base. In addition, the electronic actuation system is packaged in a way that is practical for most applications. By use of an integrated stepper motor as a prime mover for the mechanism, and since the stepper motor uses a permanent magnet rotor, there is no need to transfer electrical power to any rotating components. Additionally, the stepper motor is easily packaged behind the driven sheave 50 to minimize the axial length of the driven sheave assembly. The stepper mover also allows the rotor to remain held in a fixed position when electrical power is lost.

The present invention also has an efficient power transfer. The stepper motor provides a high torque rotary power source which is translated into linear motion to activate the sheaves. The planetary roller screw mechanism converts the rotary motion from the stepper motion to axial motion for actuating the sleeve position. This provides an effective motion change mechanism. With the planetary roller screw mechanism, there is little or no sliding friction but only rolling contacts. This provides efficiencies on the order of ninety percent. The increased efficiency allows for minimizing the stepper motor size and current draw for a given sheave force ratio change rate. As a result, the actuator cost and size are minimized for a given o performance requirement.

The rotary rotor screw mechanism in accordance with the present invention provides significant benefits over a recirculating ball screw design, for example. The roller screw design provides multiple contact points between the nut and screw, which provides higher load carrying capacity than point contacts in a ball screw design. In addition, the roller screw mechanism allows the nut to overrun the end of the screw without any complications, whereas with a ball screw design, the balls may fall out of the nut if the nut overruns the end of the screw.

While the invention described in connection with various embodiments, it will be understood that the invention is not limited to those embodiments. On the contrary, o the invention covers all alternatives, modifications, and equivalents as may be included within the spirit and scope of the appended claims.

What is claimed is:

1. A variable ratio drive system connectable between a source of rotating motion and a driven device, said system comprising:
(a) a driving member having a first rotating shaft connectable to the source of rotary motion for rotating about a drive axis;
(b) a driven member connectable to said driving member;
(c) a belt member connected between said driving member and said driven member and operable to transmit rotary motion therebetween;
(d) said driven member comprising a first sheave member and a secured sheave member each having a conical surface configured for frictional engagement with said belt member, said first sheave member being connected to a second rotating shaft, and said second sheave member being slidingly positioned on said second rotating shaft; and
(e) a sheave actuation system for slidingly changing the position of said second sheave member on said second rotating shaft;
(f) said sheave actuation system comprising a stepper motor and a planetary roller screw mechanism.

2. The variable ratio drive system as described in claim 1 further comprising an accessory member attached to said first sheave member and rotatable therewith.

3. The variable ratio drive system as described in claim 2 wherein said accessory member comprises a fan member.

4. The variable ratio drive system as described in claim 1 wherein said sleeve actuation system further includes a permanent magnetic rotor member.

5. A continuously variable belt drive system for changing the driving motion of a cooling fan member for a vehicle, said drive system comprising:
(a) a driving member assembly including a first set of pulley sheave members rotatably connected to a source of rotary motion of a vehicle;
(b) a driven member assembly including a second set of pulley sheave members rotatably connected to a shaft member;
(c) a belt member connecting said driven member and driving member together in order to transmit rotary motion of said first set of pulley sheave members to said second set of pulley sheave members;
(d) said second set of pulley sheave members comprising a forward sheave member attached to a shaft member and a rear sheave member slidingly positioned on said shaft member;
(e) a fan member coupled to said forward sheave member and rotatable therewith; and
(f) an actuation system for changing the position of said rear sheave member on said shaft member;
(g) said actuation system comprising a stepper motor and a planetary roller screw mechanism.

6. The continuously variable belt drive system as described in claim 5 wherein said actuation system further comprises a permanent magnetic rotor member.

7. An actuation system for changing the position of a pulley sheave member on a shaft member, said actuation system comprising a stepper motor and a planetary roller screw member.

8. The actuation system as described in claim 7 further comprising a permanent magnetic rotor member.
